(19) United States
(12) Patent Application Publication
(10) Pub. No.: US 2005/0221098 A1
(43) Pub. Date: Oct. 6, 2005

(54) Substrate with a self-cleaning coating

(75) Inventors: Marie-Jose Azzopardi, Les Granges Le Roi (FR); Sebastien Brasy, Montmacq (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Glass France

(21) Appl. No.: 10/511,677

(22) PCT Filed: Apr. 16, 2003
(86) PCT No.: PCT/FR03/01219

§ 371 Date: Apr. 28, 2005

(30) Foreign Application Priority Data
Apr. 17, 2002 (FR) 02/04774

(51) Int. Cl. C03C 17/34; C04B 41/52; C03C 25/52

(52) U.S. Cl. 428/446; 428/210

(57) ABSTRACT

The invention relates to a substrate (1) provided with a first coating (2) comprising at least one hydrophilic layer based on an at least partially oxidized silicon derivative, surmounted by a photocatalytic second coating (3) comprising partially crystallized titanium oxide and having a discontinuous/permeable structure. Application of this substrate to glazing, an architectural material or to mineral wool.

The invention relates to various types of material that may be found in buildings, vehicles, urban furniture or in domestic electrical appliances, namely in particular:
transparent substrates, made of glass or polymer, intended to serve as glazing, for example as a display screen;
ceramic or glass-ceramic substrates that can be used for example in domestic electrical appliances;
architectural materials, such as roof tiles, floor tiles, stone, cementitious compositions and metal surfaces; and
fibrous mineral materials, such as glass insulation wool or textile glass yarns, that can be used as filtration material, for making false ceilings, etc.

Recent studies have been carried out for the purpose of trying to improve the comfort of these materials when in use, especially to make them easier to clean, and two broad approaches have been studied in order to give these materials such a functionality.

According to a first approach, functional coatings having the feature of being highly hydrophilic have been studied and developed. This is especially the case for coatings based on silicon oxide or oxycarbide that can be deposited on glazing according to the teaching of patent WO 01/32578. This type of coating has a pronounced antisoiling effect with respect to dust, most particularly with respect to mineral dust: simply running water over the surface of such a coating, which is highly “wetting”, allows the dust to be carried away. Such running water may be natural (rain) if the substrate is used outdoors and exposed appropriately. It may also be induced: this becomes a washing operation, but one that is very easy since there is no need to rub the substrate nor is there any need to use detergents. The substrates thus treated become soiled to a lesser extent and less quickly. It is thus possible to space out more conventional washing operations with detergents (especially as regards windows). However, this hydrophilic coating has a less pronounced effect with regard to organic dust (for example that from motor vehicle exhaust gas residues, various hydrocarbon residues in the vicinity of airports, or more simply fingerprints). Such organic soiling tends to accumulate on the surface of the coating, progressively reducing, at least locally, its hydrophilicity. Its fouling delay function is therefore real, but could be improved depending on the type of soiling encountered and on the type of pollution to which the substrate is exposed.

According to a second approach, functional coatings having photocatalytic properties have been developed. These are especially coatings comprising TiO₂ at least partially crystallized especially in the anatase form, which have for example been described in patents WO 97/10185, WO 97/10186, WO 99/44954 and WO 01/66271. This type of semiconducting material, based on an optionally doped metal oxide (there are also other oxides that can be photocatalytic, such as ZnO, etc), is capable through the effect of radiation of suitable wavelength, of initiating radical reactions that cause organic compounds to oxidize: this type of coating, when sufficiently exposed to ad hoc radiation (generally ultraviolet, and possibly visible range), is therefore very effective for degrading organic soiling. Furthermore, it has been discovered that, especially when the coatings are based on titanium oxide, they also exhibit a certain hydrophilicity when exposed for a sufficiently long time to said radiation. This coating is therefore very effective in that it can degrade organic soiling and, through its hydrophilicity, remove mineral soiling. However, its activity is dependent on its exposure (for a long enough time) to radiation (of sufficient intensity) of ad hoc wavelength. The behavior of this type of coating therefore depends strongly on the environmental conditions in the case of outdoor exposure, especially the sunshine and rain conditions. Likewise, in the absence of suitable illumination, its activity at night tends to be less than its activity during the day.

The object of the invention is therefore to further improve the functionality imparted by these various types of “self-cleaning” or “fouling delay” coatings. The invention is aimed in particular at obtaining coatings that can be of enhanced efficiency and can be more “multipurpose” with regard to various aspects: firstly with regard to soiling of different chemical nature and then with regard to varied environmental conditions when the substrate is used outdoors. The object of the invention is more particularly to obtain coatings that can, even under mediocre irradiation conditions, and even at night, exhibit a certain antisoiling activity.

The subject of the invention is firstly a substrate that may essentially be transparent, especially one based on glass or one or more polymers, or may be made of a ceramic or glass-ceramic, or may even be an architectural material (of the type comprising a wall render, a concrete slab or block, architectural concrete, roof tile, material of cementitious composition, terracotta, slate, stone, or may even be a fibrous substrate, based on glass of the mineral insulation wool type, or glass reinforcement yarns). This substrate is characterized in that it is provided on at least part of its surface with a first coating comprising a layer or several stacked layers preferably based on an at least partly oxidized derivative of silicon, chosen from silicon dioxide, substoichiometric silicon oxides and silicon oxycarbide, silicon oxynitride or silicon oxycarbonitride. This first coating is chosen so as to exhibit hydrophilicity and is surmounted by a second coating chosen so as to exhibit photocatalytic properties. This second coating preferably comprises at least partly crystallized titanium oxide, especially in anatase form. This second coating has a discontinuous/permeable structure. These terms are understood to mean that the second coating is sufficiently porous and sufficiently “noncovering” to allow access to a certain portion of the external surface of the subjacent first coating. It is advantageous to choose a distribution of the second (photocatalytic) coating on the first (hydrophilic) coating that is “regular”, or as regular as possible, on the scale of 1 mm² or 1 cm² of substrate, and to have approximately the same amount and/or the same thickness of the second coating, which is preferably distributed approximately in the same way on this scale. Further details will be given later as regards the way in which the second coating is distributed on the first and how the structure of the second coating thus permits the subjacent coating to come into contact with the external atmosphere, but two cumulative or alternative situations are especially possible, namely the second coating may be chosen to have a thinness such that it is in fact in the form of islands distributed more or less randomly on the surface of the subjacent first coating. It may also have a porous structure, and an at least partly open porosity, that lets the water from the ambient atmosphere reach the first coating. Preferably, as regards the first coating and the second, the thicknesses remain within the interferential thickness range, for example of the order of at most one hundred nanometers in the case of the first coating. Especially in the case of coatings suitable for transparent substrates of the glazing type, these very small thicknesses guarantee that, even if the second coating is in fact only a collection of more or less separate islands, there is no inhomogeneity in the optical properties associated with the discontinuity of the second coating, especially no iridescence.

It has therefore been discovered in the invention that there is a very considerable synergy between the two coatings with complementary properties: the hydrophilic first coating is effective more for mineral-type soiling, whatever the irradiation conditions. It can be active through the effect of rain or by water spray. The second coating is effective for organic soiling and even mineral soiling when it has a degree of hydrophilicity, its effectiveness being dependent on the conditions of exposure to the appropriate radiation (for most of the time ultraviolet and/or visible radiation). It is furthermore designed to leave (at least partly) the first, subjacent coating its antisoiling property, allowing water to pass through it (and the dust to be carried away therewith). Furthermore, the at least partly preserved hydrophilicity of the first coating retains its antifogging and anticondensation effects, which are also highly appreciated.

This double coating is straightaway very multipurpose: in the presence of irradiation, the effectiveness in delaying fouling is very high, making use of the complementary properties of the two coatings. Even in the case of low irradiation (or at night), a certain effectiveness is retained, at least as regards mineral soiling, either thanks to natural rain or more simply by water spray. The subjacent (hydrophilic) first coating thus makes it possible to readily remove mineral soiling which is undesirable, as it is unattractive and also because its accumulation could end up deactivating/passivating the photocatalytic properties of the photocatalytic second coating. It is therefore truly a combination of effects that gives excellent results, whereas it might be expected that the photocatalytic second coating, owing to its discontinuous/porous character, would add nothing or almost nothing in terms of antisoiling properties to the subjacent hydrophilic coating, or, worse still, would remove the subjacent hydrophilic coating of its antisoiling, antifogging and anticondensation properties.

Advantageously, the substrate according to the invention is essentially transparent, flat or curved, of the glazing type, impressed or not, as it is in this type of application that the accumulation of soiling that prevents visibility is the most irksome and that washing operations are really necessary in order to guarantee their transparency.

Preferably, the first coating of hydrophilic character may be of the type described in the aforementioned patent WO 01/32578. Advantageously, it has a refractive index of between 1.45 and 1.80, especially between 1.50 and 1.75, for example between 1.55 and 1.68. Such a relatively low index, on a transparent substrate of the glass type, makes it possible to prevent a reflecting effect that may be deemed unattractive.

This coating therefore advantageously comprises Si, O, and possibly carbon and nitrogen. However, it may also include materials in a minor proportion compared with silicon, for example metals such as Al, Zn or Zr. This coating may be deposited by sol-gel or by pyrolysis, especially by CVD (chemical vapor deposition). The latter technique can be used to obtain SiOₓC_{y} or SiO₂ coatings quite easily, especially by deposition directly on the ribbon of float glass in the case of glass substrates. However, it is also possible to deposit such a coating by a vacuum technique, for example sputtering using an Si (optionally doped) target or a silicon suboxide target (for example in an oxidizing and/or nitriding reactive atmosphere).

This first coating preferably has a thickness of at least 5 nm, especially a thickness between 10 and 200 nm, for example between 30 and 120 nm.

To enhance its hydrophilicity, it has been shown that it is advantageous for this coating to have a certain roughness. This may especially take the form of nanoscale protuberances and/or indentations. They may more particularly be protuberances, at least some of which are not touching: it is thus possible to have a coating whose external face has a relatively smooth profile from which emerge protuberances that may be overlapping or touching, but at least some of which are discrete. Such surface structuring is achieved most particularly with coatings obtained by pyrolysis. In general it is also possible using this type of technique to obtain quite dense coatings that adhere strongly to the carrier substrate, and are therefore durable, to the benefit of the invention of course.

These protuberances/indentations vary in size, for example with a diameter distribution between 5 and 300 nm, especially 50 and 100 nm. The term “diameter” is understood here in the broad sense, by likening these protuberances/indentations to solid hemispheres (protuberances) or hemispherical voids (indentations). It goes without saying that this is an average size and that protuberances/indentations of more random shape, for example more elongated, are included.

These protuberances and/or indentations may also have a height (in the case of protuberances) or a depth (in the case of indentations) of between 5 and 100 nm, especially between 10 and 50 nm. This gives an indication of the maximum value for each protuberance/indentation whose size it is desired to determine.

One way of measuring these dimensions consists in carrying out measurements based on photographs taken by scanning electron microscopy (SEM).

Such photographs can also be used to determine the distribution of these indentations/protuberances per unit area of the substrate. It is thus possible to have a number of protuberances/indentations for this first coating of between 5 and 300 per μm², especially between 20 and 200 per μm², of coated substrate.

One way of measuring these hydrophilicity-enhancing protuberances/indentations consists in measuring the rms roughness expressed in nm. This first coating may thus have an rms roughness of between 4 and 12 nm, especially between 5 and 10 nm, and more particularly between 6 and 9 nm.

The second coating, that exhibiting photocatalytic properties, is preferably thin, that is to say it has a thickness of at most 10 nm, especially a thickness of at most 8 or 5 or 3 nm, in the regions where it actually overlaps the first coating. In fact, it may be so thin as to tend toward the detection limits of the machines normally used to evaluate interferential layer thicknesses. As mentioned above, the term “coating” is to be taken in its broadest sense insofar as this coating may be discontinuous, in the form of at least partly discrete islands, or so porous as to be considered as discontinuous. It is in fact just this point that is surprising in the invention, that such a coating, despite its very “tenuous” character, does provide a certain functionality.

Its presence may, perhaps more justifiably, be quantified not so much by a thickness value but by the amount of material deposited per unit area of substrate (any discontinuity in the coating is thus taken into account). In the case here, this amount may advantageously be at most 10 micrograms per cm², especially at most 5 or 3 micrograms per cm². It is preferable for this to be within the range from about 0.5 to 3 micrograms per cm², i.e. really very small amounts (compared with the amount of material per cm² provided, for example, by an SiOC-based hydrophilic first coating with a thickness of around fifty nanometers, which is already about 10 micrograms per cm² of substrate for an SiOC material, albeit less dense than bulk TiO₂).

Advantageously, this second coating will therefore be able to let the first coating “breathe” and allow at least part of the antisoiling activity associated with its hydrophilicity, that it would have in its absence, to be retained.

The second coating is preferably deposited by sol-gel, or by CVD-type pyrolysis or by a vacuum technique of the sputtering type.

From an industrial standpoint, it is most beneficial to produce this double coating continuously, by depositing the first coating and then the second by chemical vapor deposition on a ribbon of float glass, for example, when glass substrates are involved.

Advantageously, the second coating is essentially based on optionally doped titanium oxide, consisting of grains or crystallites with a diameter of between 0.5 and 100 nm, especially between 2 and 20 nm. Here again the term “diameter” is to be taken in the broad sense—it is more a determination of the size of the crystallites. The shape of the grains may approach that of a sphere or have an elongate shape of the rice grain type, or have a completely random shape. These grains/crystallites may be at least partly touching. They may also exhibit some cohesion owing to amorphous oxide that will incorporate/bind these crystallized grains.

Preferably, the ratio of the diameter of the protuberances on the external surface of the first (hydrophilic) coating to that of the grains or crystallites of the second (photocatalytic) coating is at least 2, especially at least 4, 5 or even at least 10.

Advantageously, the second coating will “follow” the roughness of the first, if there is any roughness, and even sometimes enhance it. Thus, the rms surface roughness in nm of the substrate coated with the hydrophilic first coating and with the photocatalytic second coating will be between 4 and 15 nm, especially between 5 and 12 nm, more particularly between 7 and 10 nm.

Taking an embodiment described above in which the external surface of the first coating is provided with indentations/protuberances and in which the second coating comprises grains/crystallites, these grains/crystallites may be placed between these indentations/protuberances and optionally cover, at least partly, these indentations/protuberances.

Advantageously, the transparent, especially glass, substrate of the glazing type, which is provided with the double coating according to the invention, has a light reflection R_{L} on the coating(s) side of at most 12%, especially at most 11%, under illuminant D₆₅. This thus amounts to a coating of very low reflectivity that therefore does not penalize the substrate optically, which remains quite “neutral” optically. Its colorimetric response in reflection may be very slight, and in neutral colors fairly perceptible (or almost imperceptible) to the eye, and preferably in the green-blues. This colorimetric response may for example be quantified by a* and b* values in the (L,a*,b*) colorimetry system, in which preferably b* is of negative sign. Preferably b* and a* are negative. In absolute values, a* and b* are preferably less than 5 or 4 or 3.

Advantageously, the combination of the first and second coatings has a photocatalytic activity characterized by a rate of degradation of palmitic acid of at least 5 nm/h, especially at least 10 nm/h when exposed to appropriate radiation, especially ultraviolet radiation. The conditions for the test measuring this rate of degradation will be explained in detail during the subsequent description of the examples.

Also advantageously, the combination of the two coatings exhibits hydrophilicity characterized by a water contact angle of at most 10° or 5°, with or without exposure to radiation in the ultraviolet or the visible.

The subject of the invention is also the application of the substrates according to the invention, especially those that are essentially transparent, to the manufacture of “self-cleaning” glazing that can provide, simultaneously, antisoiling, antifogging and anticondensation behavior. This may be glazing for buildings of the double-glazing type, vehicle windows of the windshield, rear window, sunroof, side window or rear-window type. They may also be windows for trains, aircraft and ships. It may also be utilitarian glazing, such as aquarium glass, shop window glass or greenhouse glass, or else glazing used in interior furnishings or in urban furniture. It may also be glazing used as display screens of the television, computer or telephone screen type. This type of coating may also be applied to electrically controllable glazing, such as wire-type or layer-type heated windows, electrochromic glazing, glazing incorporating a liquid-crystal film, electroluminescent glazing or photovoltaic glazing.

The substrate according to the invention, apart from its application as glazing, may be made of any architectural material that can be used for manufacturing partitions, wall claddings, roofing, flooring, either indoors or outdoors (metal, wood, stone, cement, concrete, terracotta, ceramic, wall render, etc.).

The substrate, if instead based on a mineral fibrous material (glass, rock, silica, etc.), may serve as filtration material or else may be used for false ceilings, which are not easy to clean.

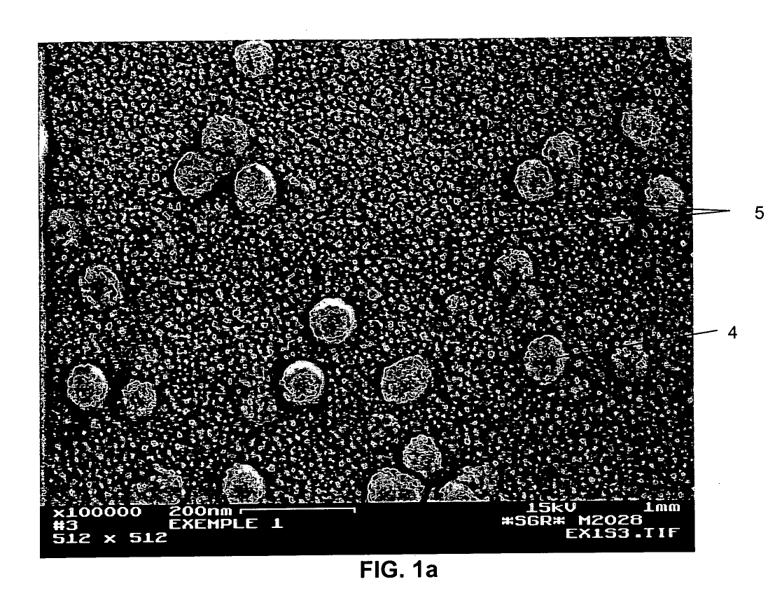

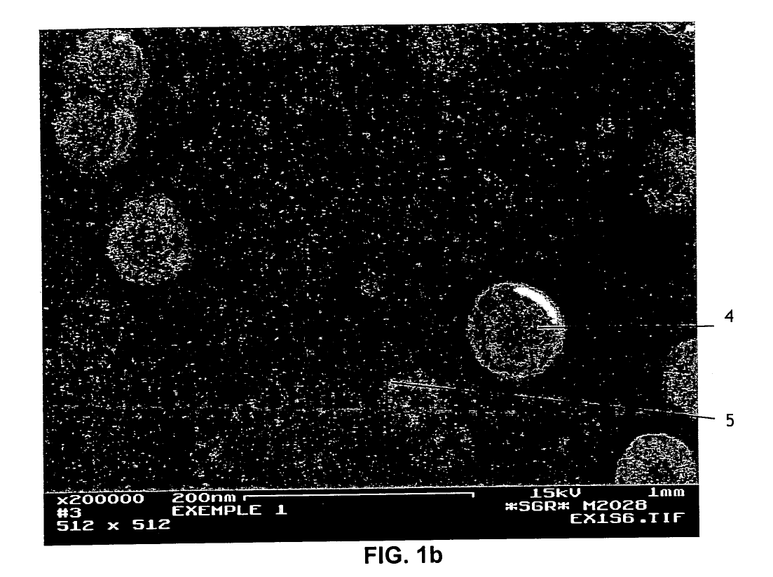

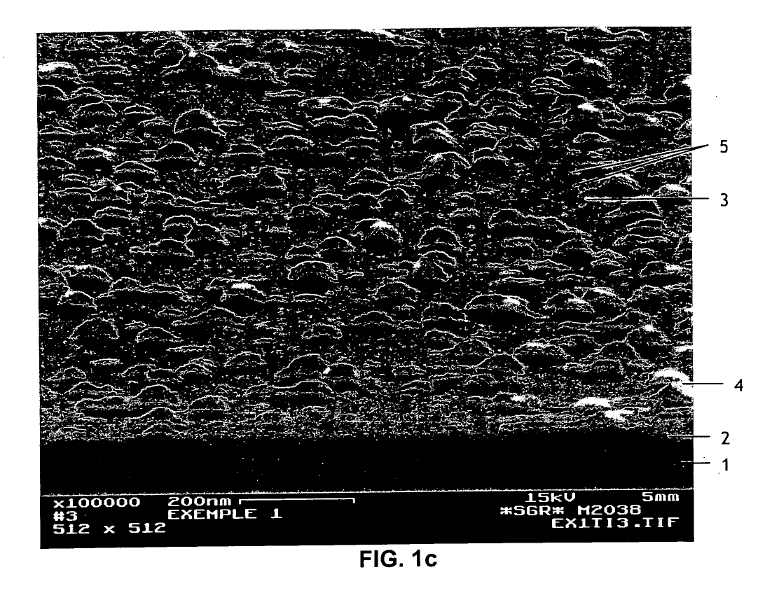

The invention will be described below with the aid of nonlimiting examples and FIGS. 1 to 3. All the figures are SEM micrographs of the examples. In all the examples, the substrate 1 is a silica-soda-time clear glass 4 mm in thickness (of the type of glass sold by Saint-Gobain Glass France under the name SGG Planilux).

### EXAMPLE 1

This example relates to the deposition, on the glass 1 again in the form of a ribbon of float glass, of a first coating 2 based on silicon oxycarbide, denoted for convenience by SiOC (without prejudging the actual amount of oxygen and carbon in the coating). This coating 2 was deposited by CVD using Si precursors, in particular using an SiH₄/ethylene mixture diluted in nitrogen, with the aid of a nozzle placed above and transversely to the ribbon float glass 1 of a flat glass production line, in the float chamber, when the glass was still at a temperature of about 600 to 700° C. The coating obtained had a thickness of about 50 nm and a refractive index of about 1.55. Still on the float line in the float chamber, and at the same glass temperature, the titanium-oxide-based coating 3 was deposited, by means of a second nozzle, using titanium isopropylate diluted in nitrogen. This coating was very thin, probably “noncovering” with respect to the subjacent coating. Its thickness was determined to be less than 5 nm, corresponding to an amount of TiO₂ of the order of 1 microgram per cm² of substrate. The photographs shown in FIGS. 1a, 1b and 1c relate to this example 1, once the glass ribbon had been cut from the float line: they show, on two different scales, seen from above and, in the case of FIG. 1c, obliquely, the coating 2 that was seeded with pseudo-circular protuberances 4 in the plane of section, and having a diameter of about 30 to 70 nm. They also show traces of the coating 3, in the form of grains 5 much smaller in size than the protuberances 4. These grains lie between the protuberances 4 and perhaps also at least on these protuberances, but this is difficult to confirm just from these micrographs. These grains have a size of around 2 to 10 nm.

The glass 1 was then subjected to two series of tests, one a natural aging test and the other an accelerated aging test.

Natural Aging:

The glass 1 provided with a double coating was exposed on the outside for 6 months at the Charles de Gaulle airport near Paris, so as to be inclined and in direct contact with rain and sunshine. This is because the environment of an airport is a very good test environment as it is a highly polluted atmosphere, especially polluted with higher hydrocarbon contents in the air than elsewhere. After 6 months, it was found that the glass retained a clean and wetting appearance: the glass treated according to the invention therefore has actual “self-cleaning” properties, even under environmental conditions that are neither very sunny nor very rainy, as encountered in the Paris region. It is therefore capable of ridding itself of organic soiling, even with a very thin if not discontinuous photocatalytic coating 3. In addition, it remains hydrophilic. For comparison, the uncoated glass of untreated SGG Planilux type, subjected to exactly the same environmental conditions, loses its wetting character after 15 days of exposure, with visible traces of droplets and dust.

Accelerated Aging:

The photocatalytic activity of the treated glass according to example 1 was firstly measured by what is called the palmitic acid test. This test consists in depositing, on 15 cm² of the surface of the treated glass, by spraying, a palmitic acid solution (8 grams of acid per 1 l of chloroform) with a glass/spray distance of 20 cm, on a vertical substrate in 3 to 4 successive passes. Next, the glass is weighed in order to determine the thickness in nanometers of palmitic acid deposited (by weighing the glass specimen before deposition of the palmitic acid). The glass was then exposed to UVA with an intensity of about 30 W/m². The photocatalytic activity was then calculated as the rate of disappearance v (in nm/h) of palmitic acid, this rate being defined as follows:
v(nm/h)=palmitic acid thickness(nm)/(2×t_{1/2 disappearance}(h)).

The value v for the treated surface of the treated glass was initially about 10 nm/h. Its water contact angle was 5—this surface was therefore strongly hydrophilic and also photocatalytic.

Variable Environment Test

This test was carried out according to the NF P 78 451 standard. It involves subjecting the glass to 4 cycles per 24 hours, with hold periods of 2 hours at 55° C. and 95% relative humidity, then 1 hour at −15° C., with transitions lasting 1 hour 30 minutes. The water contact angle was measured every 10 days as follows: the glass was exposed for 20 minutes to UV and then stored in the dark for 72 hours. The measurement was then carried out, this being an average of three measurements on three different drops.

After 10 days of testing, the water contact angle, which was 5° initially, increased to 10°. Then, after 20 days, the water contact angle dropped to 5°. This 5° value then remained approximately constant for up to 55 days. These measurements therefore merely prove that the hydrophilicity of the treated glass is indeed preserved over time, this hydrophilicity probably being a combination of the hydrophilicity of the first and of the second coating.

High Humidity Test

This test was carried out according to the EN 1096-2 standard. It involves subjecting the glass to a temperature of 40° C. in a chamber saturated with moisture, with a relative humidity of greater than 95%, with water having a conductivity of less than 30 μS and a pH of greater than 5 running over the treated face of the glass. The treated glass having undergone this test was then exposed for 10 and 20 days to UV and then stored for 72 hours in the dark, as in the previous test. The water contact angle measurement was also an average of three measurements. After 10 days, the water contact angle was 10° and after 20 days it had dropped back down to 5°.

Neutral Salt Fog Test

This test was carried out according to the EN 1036 standard. It involves placing the glass in a chamber at 35° C. with a fine spray of hot (35° C.) neutral (5% NaCl in water) brine, the treated surface being exposed to this fog. The water contact angle of the treated surface was again measured under the same conditions as the previous two tests. The contact angle remained at 5° for 55 days.

### EXAMPLE 2

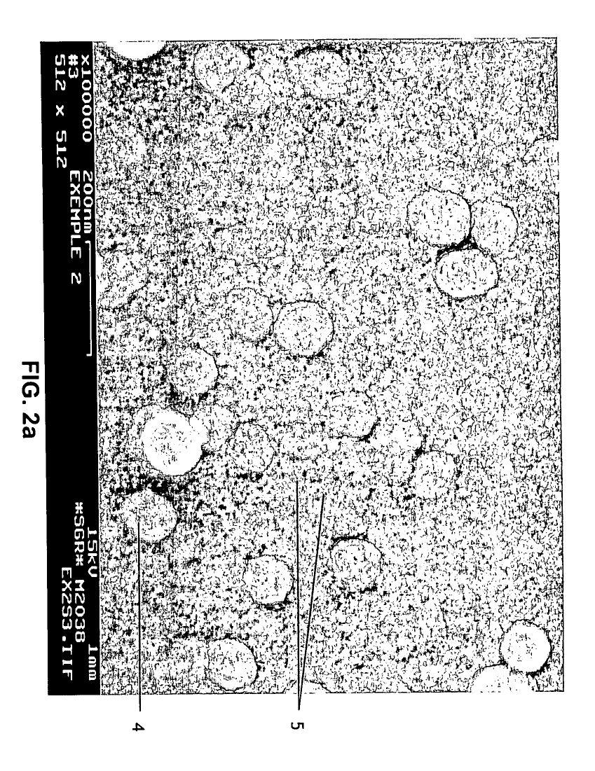

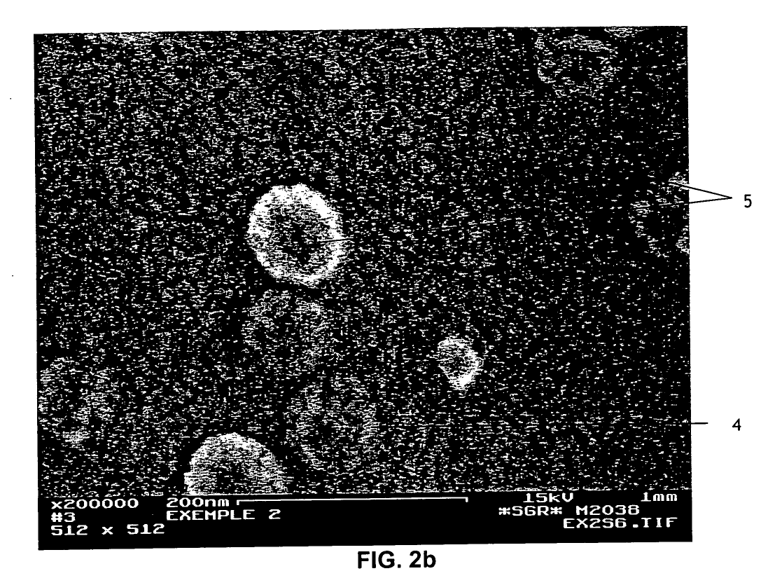

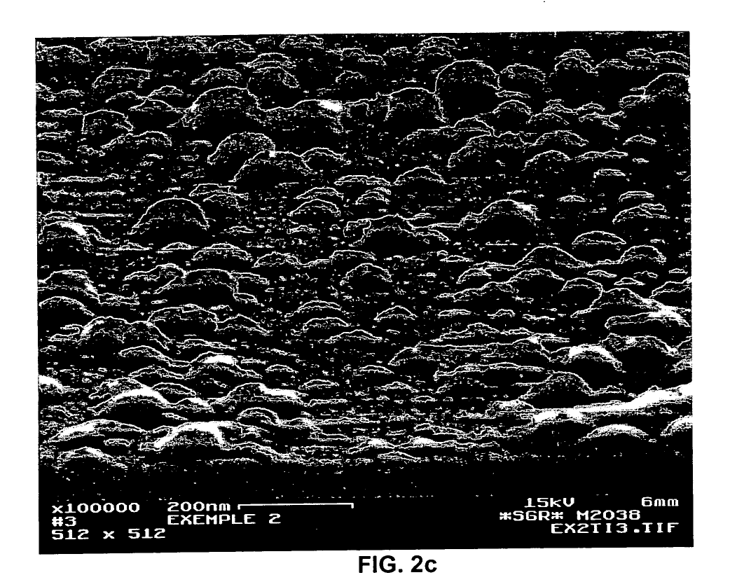

This example is similar to example 1, but the coating 3 was “thicker”, by sputtering a larger amount of titanium oxide precursor: in the case of example 2, the amount of TiO₂ deposited on the coating 2 was about 2.3 micrograms per cm² of substrate. The SEM photographs of FIGS. 2a, 2b and 2c show the treated surface seen from above and obliquely, on two different scales: they show a structure similar to that of example 1. The initial photocatalytic activity of the treated surface was 20 nm/h and its initial water contact angle was 5°. After 15 days of the variable environmental test, the water contact angle was 10°. It was even 18° after 15 days of high-humidity testing (same conditions as in example 1). Everything occurs as if the presence in larger quantity of the photocatalytic TiO₂ increases the photocatalytic activity of the coating by a factor of 2, but there should be a reason (not yet explained) why the hydrophilicity decreases slightly after accelerated environmental aging. However, it should be noted that a hydrophilic coating is still present, within the meaning of the term “hydrophilic”, with a water contact angle of at most 20° after having undergone the tests.

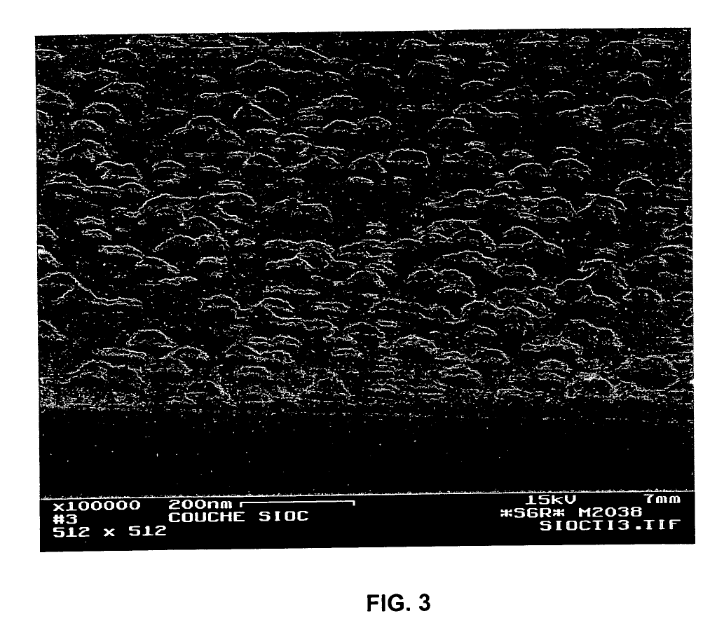

For comparison, FIG. 3 shows an SEM photograph seen from above of a glass coated only with the SiOC coating 2: the protuberances may again be seen, but the TiO₂ grains lying between these protuberances are no longer present.

1. A substrate (1), optionally transparent or optionally essentially transparent, comprising a material selected from glass; one or more polymers; a ceramic substrate; a glass-ceramic substrate; a substrate made of an architectural material; a substrate made of an architectural material of the type comprising a wall render, concrete slab or block; architectural concrete; roof tile; material of cementitious composition; terracotta; slate; stone; metal; a mineral fibrous substrate; a fibrous substrate based on glass of the insulation mineral wool type or reinforcement glass yarns; or combinations thereof; and
comprising on at least part of its surface a first coating (2), comprising a layer, or several stacked layers, based on an at least partly oxidized derivative of silicon, selected from silicon dioxide, substoichiometric silicon oxides and a silicon oxycarbide, oxynitride or oxycarbonitride, and wherein said first coating (2) exhibits hydrophilicity and is surmounted by a second coating (3) having photocatalytic properties, and which comprises at least partly crystallized titanium oxide, said second coating (3) having a discontinuous/permeable structure.

2. The substrate as claimed in claim 1, wherein said substrate is essentially transparent, flat or curved, and optionally of the impressed glazing type.

3. The substrate (1) as claimed in claim 1, wherein the refractive index of the first coating (2) is between 1.45 and 1.80.

4. The substrate (1) as claimed in claim 1, wherein the first coating (2) is deposited by sol-gel or by pyrolysis, or by a vacuum technique of the sputtering type.

5. The substrate (1) as claimed in claim 1, wherein the first coating (2) has a thickness of at least 5 nm.

6. The substrate (1) as claimed in claim 1, wherein the first coating (2) is rough, and has an external surface with nanoscale protuberances and/or indentations.

7. The substrate (1) as claimed in claim 6, wherein the first coating (2) has an external surface exhibiting protuberances, at least some of which are not touching.

8. The substrate (1) as claimed in claim 6, wherein the first coating (2) has, on the external surface, protuberances and/or indentations with a diameter of between 5 and 300 nm.

9. The substrate (1) as claimed in claim 6, wherein the first coating (2) has, on the external surface, protuberances and/or indentations with a height/depth of between 5 and 100 nm.

10. The substrate (1) as claimed in claim 6, wherein the first coating (2) has an external surface comprising between 5 and 300 protuberances per μm² of substrate.

11. The substrate (1) as claimed in claim 6, wherein the first coating (2) has an rms roughness of between 4 and 12 nm.

12. The substrate (1) as claimed in claim 1, wherein the second coating (3) has a thickness of at most 10 nm in the regions of overlap with the first coating (2).

13. The substrate (1) as claimed in claim 1, wherein the second coating (3) is essentially based on optionally doped titanium oxide, comprising grains or crystallites with a diameter of between 0.5 and 100 nm.

14. The substrate (1) as claimed in claim 6, wherein the second coating (3) is essentially based on optionally doped titanium oxide, comprising grains or crystallites, and wherein the diameter of the first coating (2) to the diameter of the grains or crystallites of the second coating (3) is at least 2.

15. The substrate (1) as claimed in claim 1, wherein the substrate provided with the first (2) and second (3) coatings has an rms roughness of between 4 and 15.

16. The substrate (1) as claimed in claim 1, wherein the second coating (3) follows the roughness of the first coating (2).

17. The substrate as claimed in claim 7 wherein the grains/crystallites of the second coating (3) lie between the indentations/protuberances of the external surface of the first coating (2), and optionally partially or fully cover said indentations/protuberances.

18. The substrate (1) as claimed in claim 1, wherein the second coating (3) corresponds to an amount of material of at most 10 micrograms per cm² of substrate.

19. The substrate (1) as claimed in claim 1, wherein the second coating (3) is deposited by sol-gel, by pyrolysis, or by a vacuum technique of the sputtering type.

20. The glass substrate (1) as claimed in claim 1, wherein the first and second coatings are deposited by chemical vapor deposition on a ribbon of float glass.

21. The substrate (1) of a glazing type as claimed in claim 1, wherein the substrate is transparent, and has, once provided with the first and second coatings, a light reflection on the coating side R_{L} of at most 12%, preferably combined with a* and b* values, such that −2<a*<0 and −5<b*<0.

22. The substrate (1) as claimed in claim 1, wherein the combination of the first and second coatings (2, 3) exhibits photocatalytic activity characterized by a rate of palmitic acid degradation of at least 5 nm/h.

23. The substrate (1) as claimed in claim 1, wherein the combination of the first and second coatings (2, 3) exhibits hydrophilicity characterized by a water contact angle of at most 20°, with or without exposure to radiation in the ultraviolet and/or in the visible.

24. A method of manufacturing a “self-cleaning,” antifogging, anticondensation and antisoiling, glazing, comprising forming the substrate of claim 1, and wherein the substrate comprises a material selected from glass, glass-ceramic or combinations thereof.

25. A method of manufacturing partitions, wall claddings, roofing and flooring, for indoors or outdoors, comprising applying to a surface, or inserting into a frame, the substrate of claim 1, and wherein the substrate comprises an architectural material.

26. A method of manufacturing false ceilings or filtration materials, comprising inserting the substrate of claim 1 into a frame, and wherein the substrate comprises an insulation mineral wool.

27. The method of claim 24, wherein the glazing is selected from the group consisting of buildings of the double-glazing type; vehicle windows of the windshield; rear window or side windows of automobiles; rear-view mirrors; windows for trains, aircraft and ships; utilitarian glazing, such as aquarium glass, shop window glass or greenhouse glass; interior furnishings; urban furniture; mirrors; screens for display systems of the computer; television or telephone type; electrically controllable glazing, such electrochromic glazing; liquid-crystal-type glazing; electroluminescent glazing and photovoltaic glazing.

28. The substrate (1) as claimed in claim 1, wherein the first coating (2) is deposited by chemical vapor deposition (CVD).

29. The substrate (1) as claimed in claim 13, wherein the second coating (3) is essentially based on optionally doped titanium oxide, comprising grains or crystallites, and wherein the diameter of the first coating (2) to the diameter of the grains or crystallites of the second coating (3) is at least 2.

30. The substrate as claimed in claim 13, wherein the grains/crystallites of the second coating (3) lie between the indentations/protuberances of the external surface of the first coating (2), and optionally partially or fully cover said indentations/protuberances.

31. The substrate (1) as claimed in claim 1, wherein the second coating (3) corresponds to an amount of a material of about 0.5 to 3 micrograms per cm².

32. The substrate (1) as claimed in claim 1, wherein the second coating (3) is deposited by chemical vapor deposition.
